(19) United States
(12) Patent Application Publication
(10) Pub. No.: US 2014/0124449 A1
(43) Pub. Date: May 8, 2014

(54) SYSTEM AND METHOD FOR CLEARING CHIPS FROM A MAGNETIC CHIP COLLECTOR

(71) Applicants: Matthew Slayter, Rockford, IL (US); Jeffrey M. Makulec, Rockford, IL (US)

(72) Inventors: Matthew Slayter, Rockford, IL (US); Jeffrey M. Makulec, Rockford, IL (US)

(21) Appl. No.: 13/668,983

(22) Filed: Nov. 5, 2012

(51) Int. Cl. B03C 1/02

(52) U.S. Cl. 210/695; 210/222

(57) ABSTRACT

A chip collector body is provided including a coupled base and elongate member. The base and elongate member have a substantially hollow interior extending from a first end to a second end, so as to form a shell. A collector element is positioned within the hollow interior. The collector element has a magnetic element positioned adjacent the second end and a flange positioned near the first end. The collector element is configured to move between a first position and a second position to selectively demagnetize the chip collector body. An axial biasing member is positioned between the flange of the collector element and a rigid surface. The axial biasing member is configured to bias the collector element into the first position.

### BACKGROUND OF THE INVENTION

Exemplary embodiments of this invention generally relate to magnetic chip collectors for collecting debris in a fluid and, more particularly, to a system and method for removing collected debris from a magnetic chip collector.

Moving pieces in a machine, such as gears and bearings for example are subjected to wear phenomena. This wear can result in debris liberated from the moving pieces entering the lubrication system of the machine. Monitoring the level of debris in the lubricant circulation system can provide an indication of such abnormal component wear requiring maintenance action. In more detail, component wear in a propulsion system (i.e. wear associated with bearing, gears, shafts and the like) is typically evidenced by particulate metal that has been removed from the component through wear and deposited in a circulating lubricant, such as oil for example. Thus, by analyzing the type and amount of metal particles in a propulsion system's circulating lubricant, an operator can assess the relative health of the propulsion system components to facilitate maintenance decisions.

A magnetic chip collector, which collects particles in the proximity of a magnetic collection element, may be used to detect wear debris in a lubricant system. Magnetic chip collectors require operators to periodically remove the collected chips to allow for physical inspection and determination of the type and amount of wear debris that has been collected. When operators attempt to remove the magnetic particles, such as by wiping the magnetic chip collector with a cloth, many of the particles remain attached to the magnetic chip collector as a result of the magnetic force. In addition, the magnetic force may act on some of the particles on the cloth, attracting them from the cloth back to the magnetic chip collector.

### BRIEF DESCRIPTION OF THE INVENTION

According to one embodiment of the invention, a chip collector body is provided including a coupled base and elongate member. The base and elongate member have a substantially hollow interior extending from a first end to a second end, so as to form a shell. A collector element is positioned within the hollow interior. The collector element has a magnetic element positioned adjacent the second end and a flange positioned near the first end. The collector element is configured to move between a first position and a second position to selectively demagnetize the chip collector body. An axial biasing member is positioned between the flange of the collector element and a rigid surface. The axial biasing member is configured to bias the collector element into the first position.

According to another embodiment of the invention, a method for removing magnetic particles from a chip collector body of a magnetic chip collector is provided including separating the chip collector body from a housing. The chip collector body is then demagnetized, and the magnetic particles are removed from a first end of the chip collector body.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an exemplary magnetic chip collector;

FIG. 2 is a cross-sectional view of a chip collector body according to an embodiment of the invention; and

FIG. 3 is a cross-sectional view of a chip collector body according to an embodiment of the invention.

The detailed description explains embodiments of the invention, together with advantages and features, by way of example with reference to the drawings.

### DETAILED DESCRIPTION OF THE INVENTION

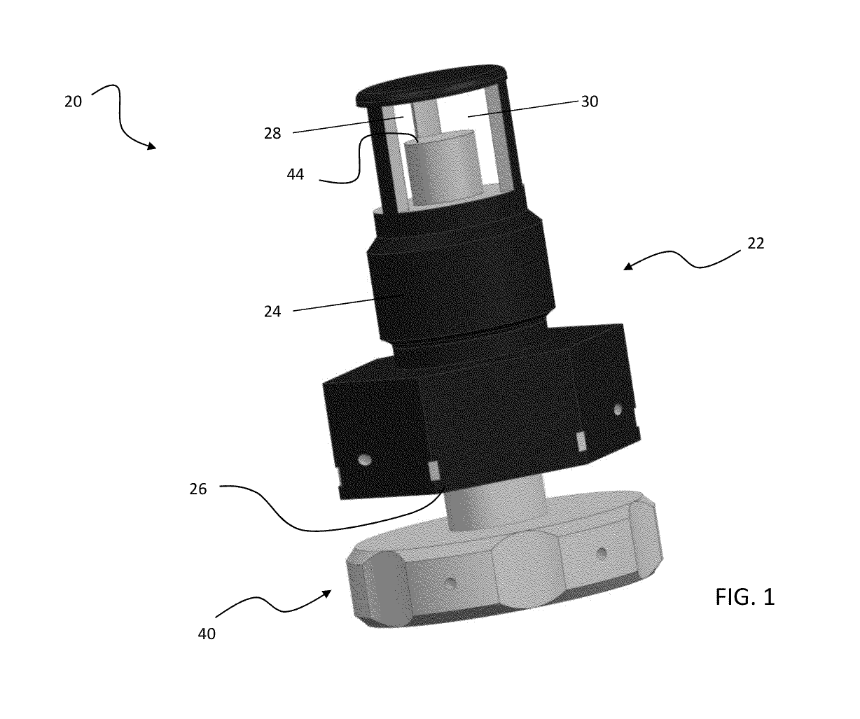

Referring to FIG. 1, a magnetic chip collector 20 used to collect chips from a lubricant, such as in a gearbox or starter for example, is illustrated. The magnetic chip collector 20 includes a generally static housing 22 consisting of an elongate annular body 24 having a substantially hollow interior 26. In one embodiment, the annular body includes an inlet 28 and an outlet 30 such that a lubricant may flow through a portion of the hollow interior 26. A chip collector body 40 is removably insertable into the hollow interior 26 of the annular body 30 to prevent drainage of the lubricant from within the housing 22. When the chip collector body 40 is located within the hollow interior 26 of the housing 22, lubricant flows directly adjacent a portion, such as the second end 44 for example, of the chip collector body 40.

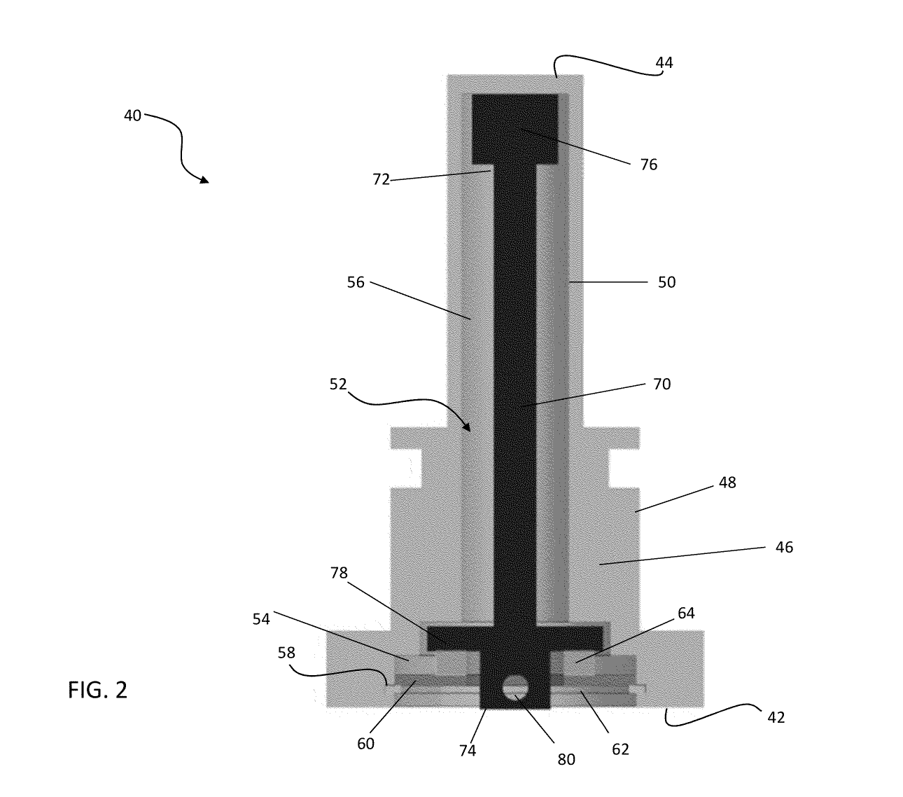

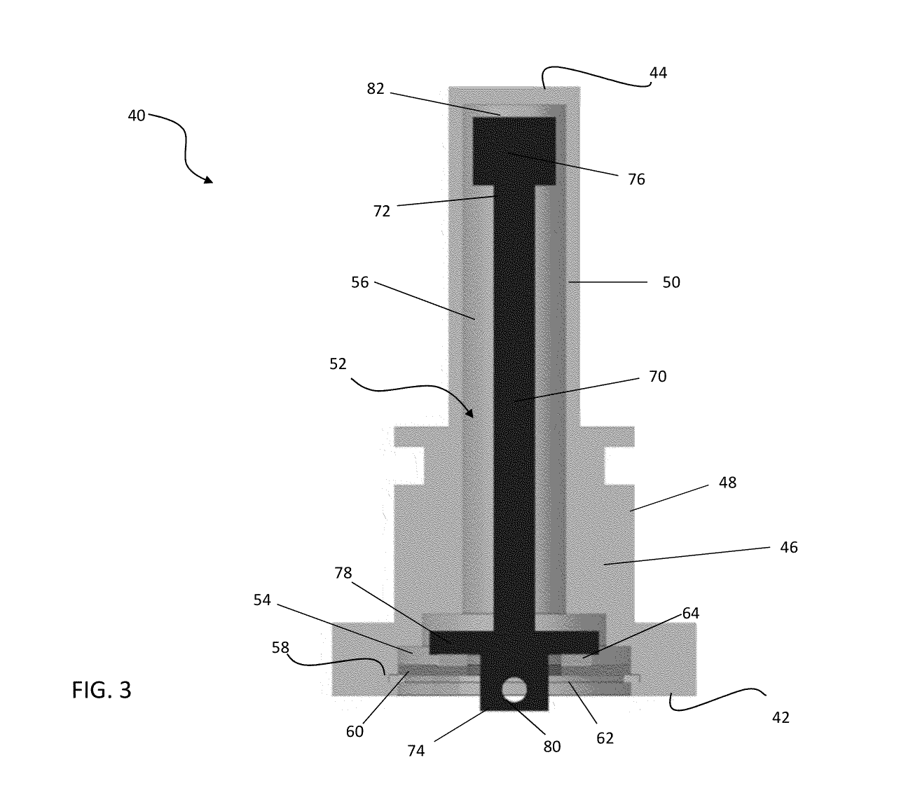

The chip collector body 40 is provided in more detail in FIGS. 2 and 3. The chip collector body 40 includes a base 46 positioned at a first end 42. As is known in the art, the exterior 48 of the base 46 is generally contoured to block the hollow interior 26 of the housing 22, to prevent lubricant from leaking therefrom. An elongate member 50 extends from the base 46 to a second end 44 of the chip collector body 40. In one embodiment, the base 46 and elongate member 50 are formed integrally from a ferrous material. Similar to the housing 22, the chip collector body 40 is formed with a hollow interior 52 extending from the first end 42 to adjacent the second end 44 such that the base 46 and elongate member 50 form a substantially hollow shell. The cross-section of the hollow interior 52 may be non-uniform over the length of the chip collector body 40. In one embodiment, a first portion 54 of the hollow interior 52 adjacent the first end 42 of the chip collector body 40 has a width larger than a second portion 56 of the hollow interior 52 extending from the base 46 through the elongate member 50.

A collector element 70 is also positioned within the hollow interior 52 and extends from the first end 42 to adjacent the second end 44 of the chip collector body 40. Arranged at a first end 72 of the collector element 70 is a magnetic element 76, such as a permanent magnet for example. Positioned near the second end 74 of the collector element 70 is a flange 78. In one embodiment, the flange 78 is arranged within the hollow interior 52 adjacent both the first portion 54 and the second portion 56. In one embodiment, the diameter of the flange 78 is larger than the diameter of the collector element 70 extending between the flange 78 and the magnetic element 76.

Mounted near the first end 42 of the chip collector body 40, within the first portion 54 of the hollow interior 52, is a substantially flat disc 60 having a rigid surface, for example a washer. A retaining device 62, such as a retaining clip for example, is positioned within the hollow interior 52 directly adjacent a surface of the disc 60, and between the disc 60 and the first end 42. The edges of the retaining device 62 are arranged within an inlet 58 of the hollow interior 52 such that the retaining device 62 is prohibited from moving relative to the base 46. In one embodiment, the diameter of the retaining device 62 is larger than the diameter of the disc 60. Thus, the retaining device 62 serves to keep the disc 60 within the chip collector body 40.

The second end 74 of the collector element 70 protrudes through a central hole in both the disc 60 and the retaining device 62. In one non-limiting embodiment, the second end 74 of the collector element 70 includes a through bore 80 such that a ring or other device (not shown) for applying a force to the collector element 70 may be connected thereto. Positioned between the flange 78 of the collector element 70 and the disc 60 is an axial biasing member 64, such as a wave spring or coil spring for example.

The collector element 70 is configured to move relative to the chip collector body 40 between a first position and a second position to selectively demagnetize the chip collector body 40. When the collector element 70 is in the first position (FIG. 2), the magnetic element 76 located at the first end 72 of the collector element 70 directly contacts the second end 44 of the chip collector body 40. As illustrated in FIG. 3, when the collector element 70 is in the second position, an air gap 80 exists between the magnetic element 76 and the second end 44 of the chip collector body 40. Lubricant flows through the housing 22 (FIG. 1) adjacent the second end 44 of the chip collector body 40 when the chip collector body 40 is installed within the hollow interior 26 of the housing 22. When the collector element 70 is in the first position, the chip collector body 40 actively attracts magnetic particles in the lubricant to the second end 44 as a result of the magnetic force created at the second end 44 by contact with the magnetic element 76.

To move the collector element 70 to the second position, an axial force is applied to the second end 74 of the collector element 70, such as through a ring or other device connected thereto. As a result, the flange 78 compresses the axial biasing member 64 against the rigid surface of the disc 60. The axial deformation of the biasing member 64 allows the collector element 70 to translate such that an air gap 82 is formed between the first end 72 of the collector element 70 and the second end 44 of the chip collector body 40. In this second position, magnetic particles are no longer attracted to the second end 44 of the chip collector body 40 because the gap 82 prevents the magnetic force generated by the magnetic element 76 from transferring to the second end 44. When the chip collector body 40 is demagnetized, the magnetic particles are easily removed from the second end 44, such as by wiping the body 40 with a cloth for example. Once the force is removed from the second end 74 of the collector element 70, the axial biasing member 64 will bias the collector element 70 back to the first position.

Because the collector element 70 may be moved to selectively demagnetize the chip collector body 40, the ease of removing of magnetic particles from the second end 44 of the chip collector body 40 is significantly improved. In addition, the percentage of particles being removed from the chip collector body 40 will increase because the magnetic force from the magnetic element 76 will not act on the particles as they are removed. This in turn, will allow for a more accurate analysis of the wear occurring within the system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A chip collector body comprising:
a coupled base and elongate member having a substantially hollow interior extending from a first end to a second end so as to form a shell;
a collector element positioned within the hollow interior having a magnetic element positioned adjacent the second end and a flange near the first end, the collector element is configured to move between a first position and a second position to selectively demagnetize the chip collector body; and
an axial biasing member positioned between the flange of the collector element and a rigid surface, wherein the axial biasing member is configured to bias the collector element into the first position.

2. The chip collector body according to claim 1, wherein when in the first position, the magnetic element is adjacent the second end and when in the second position an air gap exists between the magnetic element and the second end.

3. The chip collector body according to claim 1, wherein the axial biasing member is a wave spring.

4. The chip collector body according to claim 1, wherein the base and elongate member are integrally formed from a ferrous material.

5. The chip collector body according to claim 1, further comprising a retainer device positioned adjacent the rigid surface, wherein the retainer device is configured to prevent movement of the rigid surface within the hollow interior.

6. The chip collector body according to claim 5, wherein the rigid surface is a washer.

7. The chip collector body according to claim 1, wherein an exterior of the base is contoured to block a fluid flow from exiting a housing of a magnetic chip detector when connected to the housing.

8. A method for removing magnetic particles from a chip collector body of a magnetic chip collector comprising:
separating the chip collector body from a housing;
demagnetizing the chip collector body; and
removing the magnetic particles from a first end of the chip collector body.

9. The method according to claim 8, wherein the chip collector body is demagnetized by applying a force to a portion of a collector element housed within a hollow interior of the chip collector body.

10. The method according to claim 9, wherein application of a force causes a magnetic element mounted at a second end of the collector element to move from a first position to a second position.

11. The method according to claim 10, wherein in the first position the magnetic portion is in contact with the first end of the chip collector body and in the second position, an air gap exists between the magnetic portion and the first end of the chip collector body.

12. The method according to claim 8, wherein the magnetic particles are removed by wiping the first end of the chip collector body with a cloth.
